(19) United States
(12) Patent Application Publication
(10) Pub. No.: US 2012/0037378 A1
(43) Pub. Date: Feb. 16, 2012

(54) TREE PROTECTION SYSTEM

(75) Inventor: Stephen P. Fenton, Aberdeen (GB)

(73) Assignee: VETCO GRAY INC., Houston, TX (US)

(21) Appl. No.: 13/172,126

(22) Filed: Jun. 29, 2011

Related U.S. Application Data
(60) Provisional application No. 61/372,388, filed on Aug. 10, 2010.

(51) Int. Cl. F17D 5/00

(52) U.S. Cl. 166/360

(57) ABSTRACT

A subsea wellhead assembly having a net that protects the wellhead assembly from impacts with falling objects. The net can be deployed from a vessel onto a wellhead on the seafloor, or mounted onto a wellhead component above the sea surface and lowered with the wellhead component. The net can be retractable, so that an ROV can access the wellhead assembly by temporarily moving the net into a retracted configuration, then redeploying the net when finished accessing the wellhead assembly.

### RELATED APPLICATIONS

This patent application is a non-provisional and claims priority to and the benefit of U.S. Provisional Patent Application No. 61/372,388 filed on Aug. 10, 2010, incorporated by reference herein in its entirety.

### FIELD OF THE INVENTION

This invention relates in general to production of oil and gas wells, and in particular to a protective net system deployed over a subsea wellhead assembly.

### DESCRIPTION OF RELATED ART

Typically mounted on any wellbore is a wellhead assembly having valves for controlling the flow of fluids from the wellbore as well as and ports for access to the wellbore. As such, wellhead assemblies normally include actuators associated with the valves and ports. When located subsea, the wellhead assemblies generally include control panels where remotely operated vehicles (ROV) may dock and interface with the wellhead actuators via hot stabs in the control panels. Because to be accessible by an ROV, the control panels are usually on an outer surface of the wellhead assembly. As the control panels are exposed to the surroundings of the wellhead assembly, they are unprotected from impacts that sometimes occur from objects dropped from the sea surface or those that may topple over. While some wellhead assemblies can include a metal pane covering an upper surface, the wellhead assembly may still be susceptible to damage from side or lateral impacts. In some instances subsea wellheads are protected by covers that envelope the wellhead assembly. The covers usually have openings in their sidewalls so an ROV can access the wellhead assembly. These covers though are often large making them unwieldy or heavy and because of the openings, the wellhead assembly within remains vulnerable to damaging impact from a falling and/or toppling object.

### SUMMARY OF THE INVENTION

Disclosed herein is an example of a wellhead assembly having a protective netting. In an example embodiment the wellhead assembly includes a wellhead housing, a production tree mounted on the wellhead housing, and a net disposed over the wellhead housing and production tree. The net has an access therethrough than can be selectively opened and closed so the wellhead assembly can be accessed. In an example embodiment, the wellhead assembly also includes a frame member for supporting the net thereon. Optionally, the net can include side panels disposed adjacent a lateral perimeter of the frame. The access can be made up of members that attach to and slide along vertical portions of the frame; thus by coupling lateral ends of the side panels to the sliding members, when the side panels are urged in a direction parallel to the vertical portions of the frame, the side panels move away from a protecting position and into a position so that the wellhead assembly may be accessed. In an example embodiment, the sliding members are collar like and circumscribe a vertical portion of the frame; ends of horizontal net members attached to the sliding members. In an alternate example embodiment, the access is a vertical slit in the net. In an example embodiment, the net is a series of horizontal and vertical net members that are attached to each other and cross over one another.

Also provided and described herein is a method of protecting a wellhead assembly. In an example embodiment the method includes providing a protective netting having net elements and an access through the net elements that can be opened and closed. The entire wellhead assembly is protected from falling objects by disposing the protective netting over the wellhead assembly. Accessing the wellhead assembly occurs through the access. In an example embodiment, the method further includes providing a frame over the wellhead assembly for supporting the netting. In an example embodiment, the access is a vertical slit in the protective netting. In an example embodiment, a frame is provided that has elongate support posts equipped with sliding attachments on the support posts. Thus by mounting the protective netting on the frame so that at least a portion of the protective netting attaches to the sliding attachments, when the sliding attachments are moved along the support posts, the portion of the protective netting moves away from the wellhead assembly to define the access. In an example embodiment, the attachments are urged along the support posts with an arm attached to a remotely operated vehicle (ROV), this moves the portion of the protective netting to define an opening through the protective netting. With the access in an open configuration, the wellhead assembly can be manipulated with the ROV. In an example embodiment, the protective netting is deployed from a vessel to subsea and onto the wellhead assembly. In an example embodiment, the protective netting and the wellhead assembly are deployed together subsea.

### BRIEF DESCRIPTION OF THE DRAWINGS

FIG. 1A is a side partial sectional view of a subsea wellhead assembly on the seafloor with a protective net.

FIG. 1B is a perspective view of the subsea wellhead assembly of FIG. 1A.

FIG. 2 is an alternate example of a protective net used with a wellhead assembly on the seafloor.

FIG. 3A is a perspective view of a subsea wellhead assembly with a protective net being lowered from a vessel to the seafloor.

FIG. 3B is a perspective view of the subsea wellhead assembly and protective net of FIG. 3A on the seafloor.

FIG. 4 is a side perspective view of the subsea wellhead assembly of FIG. 1 with a protective net assembly having an opening through a protective net.

FIG. 5A is an alternate embodiment of a wellhead assembly having a protective netting in accordance with an embodiment of the present invention.

FIG. 5B is an embodiment of the wellhead assembly of FIG. 5A with a remotely operated vehicle creating an access in the protective netting in accordance with the present invention.

FIG. 5C is a detail of an example of an attachment between the protective netting and a support post.

### DETAILED DESCRIPTION OF THE INVENTION

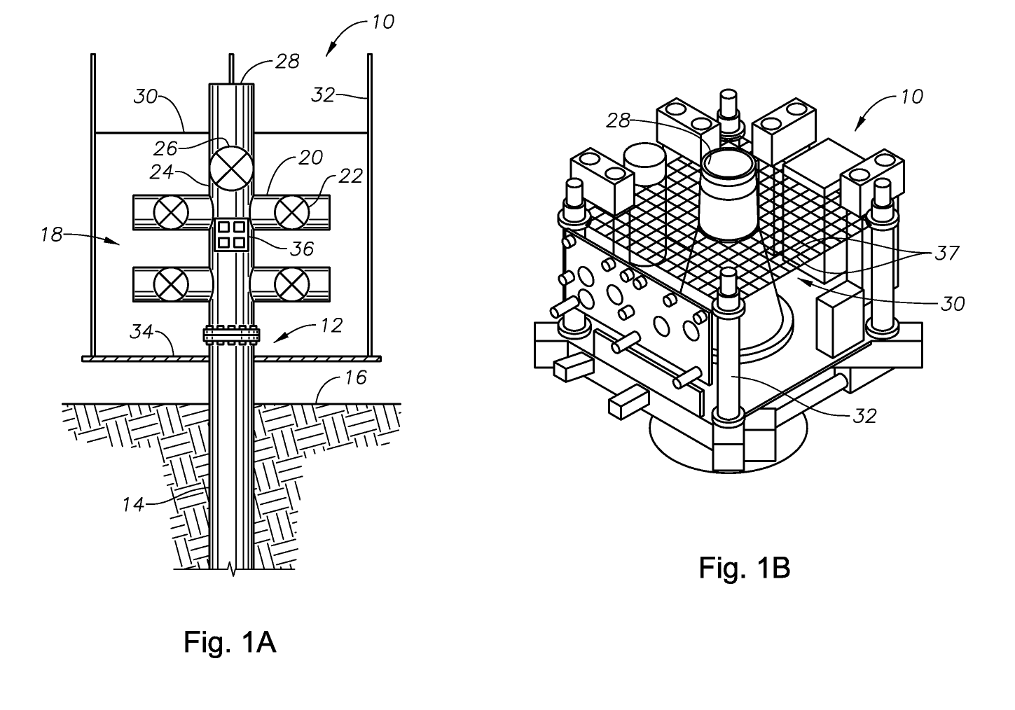

FIG. 1A illustrates an example embodiment of a subsea wellhead assembly 10 in a partial side sectional view. The subsea wellhead assembly 10 includes a wellhead housing 12 shown mounted over casing 14 that is inserted into a subsea formation 16. A coupling mounts a production tree 18 on the wellhead housing 12. The production tree 18 typically includes laterally projecting fluid flow lines 20 having wing valves 22 disposed within the lines 20. In one of many possible configurations, a main bore 24 projects vertically along the production tree 18 and in line with the wellhead housing 12. A swab valve 26 is set in the main bore 24 for controlling the flow through the main bore 24. Projecting upward from the end of the main bore 24 is a reentry mandrel 28.

A protective net 30 is illustrated spanning between and connected to vertically mounted guideposts 32 that are oriented substantially parallel with the main bore 24. The lower ends of the guidepost 32 are mounted on a support frame 34 shown mounted on the wellhead housing 12 and radially extending outward. The support frame 34 can be made up of individual structural elements or a plate-like planar structure. The subsea well head assembly 10 also includes a service control module (SCM) 36 for local control of the valves 22, 26 and other mechanisms provided on the wellhead assembly 10. A control line (not shown), such as a flying lead, can be attached to the SCM 36 for delivering control commands to and from the SCM 36. FIG. 1B provides a perspective view of the wellhead assembly 10 of FIG. 1A. In the embodiment of FIG. 1B, the net 30 includes a series of interconnecting net members 37 that are strategically spaced apart so the net 30 has sufficient strength to protect components of the wellhead assembly 10 from falling debris or other impacts.

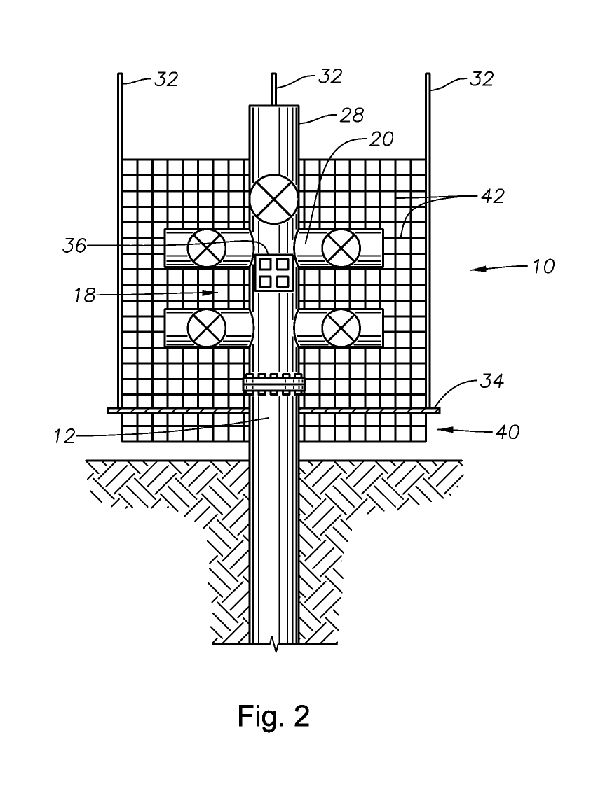

FIG. 2 depicts an alternative embodiment of a net 40 that can be used for protecting a wellhead assembly 10 subsea. In this example the net 40 envelopes the sides and the overhead of the wellhead assembly 10. The net 40 of FIG. 2 is made of interconnected net members 42 strategically spaced to provide an adequate barrier for falling and/or toppling objects to prevent impact with the wellhead assembly 10. The net members 37 and/or 42 can be made from lines, ropes, straps, monofilament, or any other type of elongated member. In one example, the net members 37 and 42 are formed from Kevlar®; optionally, other aramid or carbon fibers can be used for forming the net members 37 and 42. The dimensions, spacing, and arrangement of the net members 37, 42 may vary on the particular application of the net 30, 40; these details however are within the capabilities of those skilled in the art and may be determined without undue experimentation.

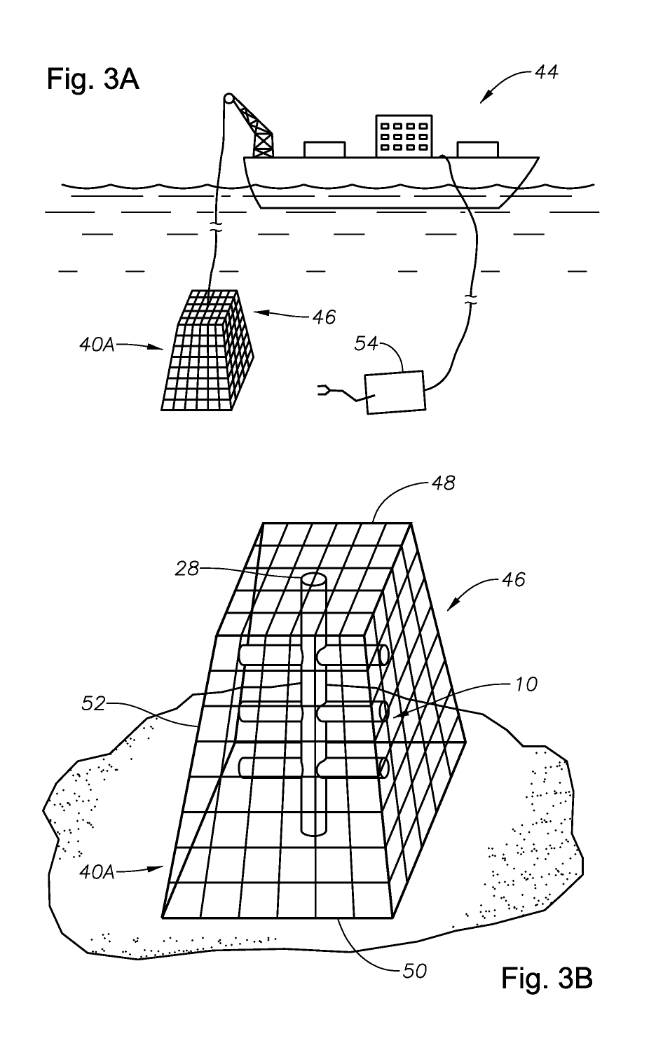

FIG. 3A illustrates in a perspective view an example of using a workboat 44 for deploying a net 40A shown set on a frame 46. The net 40A and frame 46 are lowered to the seafloor for protecting the subsea wellhead assembly 10 (FIG. 3B). Referring now to FIG. 3B, the frame 46 includes upper horizontal girders 48 arranged in a rectangle that circumscribes the reentry mandrel 28. In an example embodiment, the reentry mandrel 28 inserts through the portion of the net 40A set within the upper horizontal girders 48. Lower girders 50 are shown horizontally mounted on the seafloor and form a rectangular-like shape having an outer perimeter greater than the upper girders 48. Vertically mounted posts 52 attach between the upper and lower girders 48, 50. Since the lower girders 50 have a perimeter larger than the upper girders 48, the vertical posts 52 angle radially outward with distance away from the upper girders 48.

Referring back to FIG. 3A, although the net 40A and frame 46 are shown being lowered subsea from the workboat 44, the net 40A and frame 46 may also be lowered from other types of vessels, including any type of an offshore platform. A remote operated vehicle (ROV) 54, optionally deployed from the workboat 44, is adjacent the net 40A and may be used to aid in laying the net 40A and frame 46 over the wellhead assembly.

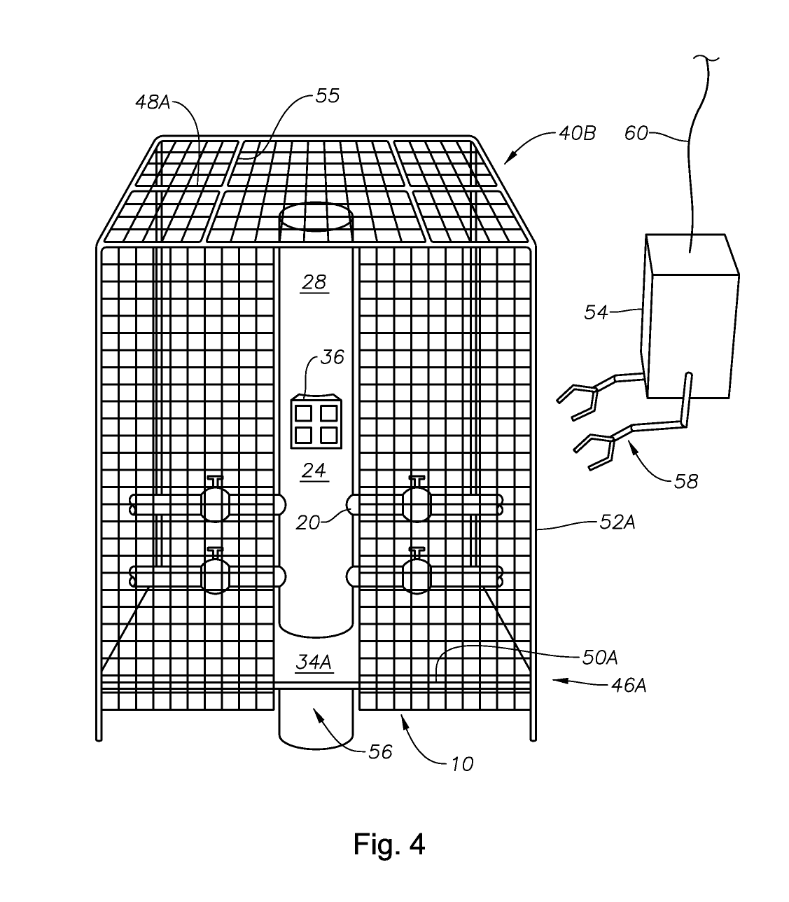

Referring now to FIG. 4, a perspective view is shown of an alternate frame 46A with a protective net 40B. In this example, the frame 46A is largely rectangular with upper and lower rectangularly shaped girders 48A, 50A that circumscribe the frame 46A at vertically spaced apart locations. As such, the girders 48A, 50A of FIG. 4 have largely the same dimensions. Vertical posts 52A are shown mounted between the respective corners of the upper and lower girders 48A, 50A and extending largely parallel to the main bore 24 of the subsea assembly 10. Included with the upper girder 48A are horizontal joists 55 shown set between parallel members of the upper girders 48A. The combination of the upper girders 48A and the horizontally mounted joists 55 provide an upper surface for supporting the net 40B. The vertical posts 52A define a vertical perimeter for the sides of the net 40B. A vertically extending slit 56 on one side of the net 40B of FIG. 4 defines an access by forming an opening by which the wellhead assembly 10 may be accessed. In an example embodiment, the ROV 54 may access the wellhead assembly 10 through the slit 56. Optionally, the slit 56 may be on another side of the net 40B, or further optionally, the net 40B may include more than one slit 56 In the embodiment of FIG. 4 the ROV 54 includes a mechanical arm 58 and may be controlled via an attached tether line 60. The arm 58 can be used to slide apart the portions of the net 40B adjacent the slit 56 to form an opening through the net 40B for accessing the subsea wellhead assembly 10.

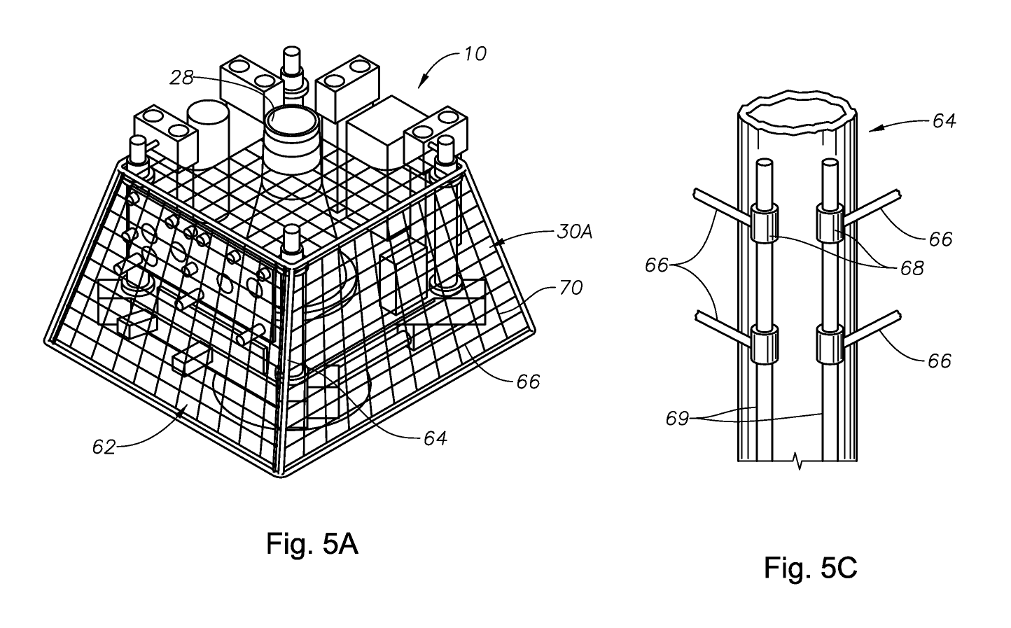

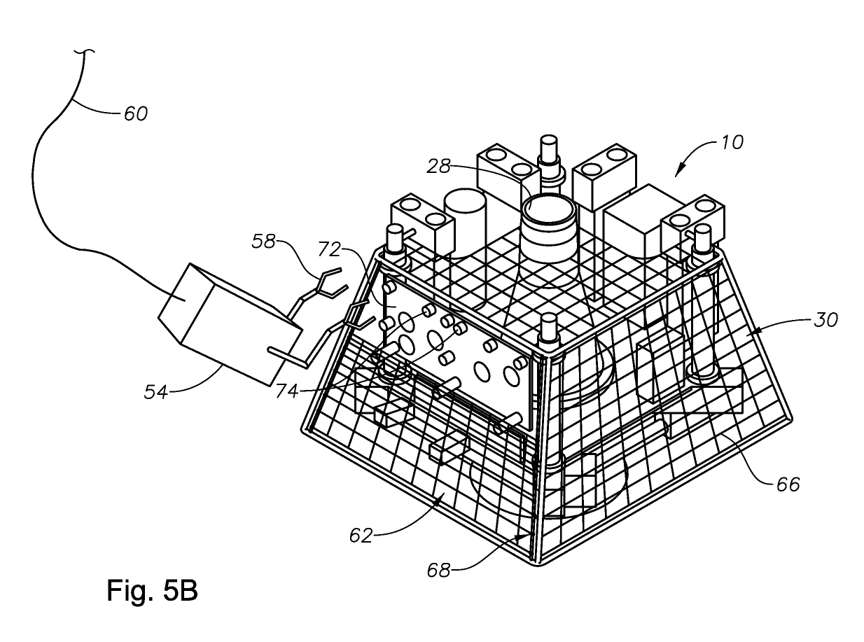

FIG. 5A illustrates an alternate example embodiment of the net 30A used for protecting the wellhead assembly 10 where the net 30A further includes side panels 62 that drape along the lateral sides of the wellhead assembly 10. The panels 62 are supported by optional posts 64. The panels include horizontal net members 66 that mount to the posts on sliding attachments 68. Vertical net members 70 may attach across the horizontal members 66 for enhancing the integrity of the panels 62. FIG. 5B depicts an example feature of the net 30A wherein an arm(s) 58 of the ROV 54 temporarily moves a portion of one of the panels 62 away from a control panel 72 by downwardly sliding the horizontal members 66 to urge the sliding attachments 68 along the posts 64 thereby defining an access by forming an opening. Hot stabs 74 and other attachments on the control panel 72 can be accessed by the ROV 54, then the panels 62 returned to their configuration of FIG. 5A and in a protecting position. An example embodiment of the sliding attachment 68 is shown in expanded detail in FIG. 5C where the sliding attachments 68 mount on rods 69 attached to the posts 64 and are slidable over the rods 69. In an example embodiment, a coefficient of friction between the sliding attachment 68 and rods 69 is maintained at a level to resist sliding movement from gravity thereby maintaining a structural form when left unattended.

While the invention has been shown or described in only some of its forms, it should be apparent to those skilled in the art that it is not so limited, but is susceptible to various changes without departing from the scope of the invention.

What is claimed is:

1. A wellhead assembly comprising:
a wellhead housing;
a production tree mounted on the wellhead housing;
a net disposed over the wellhead housing and production tree; and
a selectively openable and closable access in the net.

2. The wellhead assembly of claim 1, further comprising a frame member for supporting the net thereon.

3. The wellhead assembly of claim 2, wherein the net includes side panels disposed adjacent a lateral perimeter of the frame, and wherein the access comprises slidable members attached to vertical portions of the frame and where the lateral ends of the side panels couple to the slidable members, so selectively urging the side panels in a direction parallel with the vertical portions of the frame moves the side panels away from a protecting position and into a position so that the wellhead assembly may be accessed.

4. The wellhead assembly of claim 3, wherein the slidable member comprises a collar like assembly that circumscribes a vertical portion of the frame and has ends of horizontal net members attached thereto.

5. The wellhead assembly of claim 1, wherein the selectively openable and closable access in the net comprises a vertical slit in the net.

6. The wellhead assembly of claim 1, wherein the net comprises a series of horizontal and vertical net members that are attached to and cross one another.

7. The wellhead assembly of claim 1, further comprising a frame assembly comprising interconnected elongate frame members on which the net is supported.

8. A method of protecting a wellhead assembly comprising:
(a) providing a protective netting having net elements and a selectively openable and closeable access through the net elements;
(b) protecting the entire wellhead assembly from falling objects by disposing the protective netting over the wellhead assembly; and
(c) accessing the wellhead assembly through the access.

9. The method of claim 8, further comprising providing a frame over the wellhead assembly for supporting the netting.

10. The method of claim 8, wherein the openable and closeable access comprises a vertical slit in the protective netting.

11. The method of claim 8, further comprising providing a frame having elongate support posts and sliding attachments on the support posts, mounting the protective netting on the frame so that at least a portion of the protective netting attaches to the sliding attachments, wherein the portion of the protective netting defines the access by selectively urging the sliding attachments along the support posts.

12. The method of claim 11, further comprising accessing the wellhead assembly by sliding attachments along the support posts with an arm attached to a remotely operated vehicle (ROV) thereby moving the portion of the protective netting to define an opening through the protective netting and manipulating the wellhead assembly with the ROV.

13. The method of claim 8, further comprising deploying the protective netting from a vessel to subsea and onto the wellhead assembly.

14. The method of claim 8, further comprising deploying the protective netting and the wellhead assembly together subsea.
